(19) United States
(12) Patent Application Publication
(10) Pub. No.: US 2014/0164487 A1
(43) Pub. Date: Jun. 12, 2014

(54) FILE SAVING SYSTEM AND METHOD

(71) Applicants: HON HAI PRECISION INDUSTRY CO., LTD., New Taipei (TW); HONG FU JIN PRECISION INDUSTRY (ShenZhen) CO., LTD, Shenzhen (CN)

(72) Inventors: ZHI-QUAN CHAI, Shenzhen (CN); DA-PENG LI, Shenzhen (CN); HAI-HONG LIN, Shenzhen (CN); CHUNG-I LEE, New Taipei (TW)

(73) Assignees: HON HAI PRECISION INDUSTRY CO., LTD., New Taipei (TW); HONG FU JIN PRECISION INDUSTRY (ShenZhen) CO., LTD, Shenzhen (CN)

(21) Appl. No.: 14/065,491

(22) Filed: Oct. 29, 2013

(30) Foreign Application Priority Data
Dec. 12, 2012 (CN) 201210533979X

(51) Int. Cl. H04L 29/06

(52) U.S. Cl. CPC H04L 29/06047
USPC 709/203

(57) ABSTRACT

An assignment server receives two or more data blocks of the file from a client. The assignment server deletes repetitive data blocks from the client, and sets a storage space in a storage server for storing each data block from the client. The assignment server uploads each data block from the client into the storage space corresponding to the data block.

### BACKGROUND

1. Technical Field

The embodiments of the present disclosure relate to file management technology, and particularly to a file saving system and method.

2. Description of Related Art

A data center is a facility which houses a large number of computers and stores huge amounts of data. By using cloud computing, the files are uploaded into a data center. However, at present, a file stored in the data center may include one or more portions of the same data, which waste a lot of storage space. Therefore, there is room for improvement in the art.

### BRIEF DESCRIPTION OF THE DRAWINGS

FIG. 1 is a block view of one embodiment of an assignment server including a file saving system.

FIG. 2 is a block diagram of one embodiment of function modules of the file saving system in FIG. 1.

FIG. 3 is a flowchart of one embodiment of a file saving method.

FIG. 4 is a flowchart of one embodiment of downloading a file from a storage server.

### DETAILED DESCRIPTION

The disclosure is illustrated by way of examples and not by way of limitation in the figures of the accompanying drawings in which like references indicate similar elements. It should be noted that references to “an” or “one” embodiment in this disclosure are not necessarily to the same embodiment, and such references mean “at least one.”

In general, the word “module”, as used herein, refers to logic embodied in hardware or firmware, or to a collection of software instructions, written in a programming language, such as, Java, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable media include CDs, DVDs, BLU-RAY, flash memory, and hard disk drives.

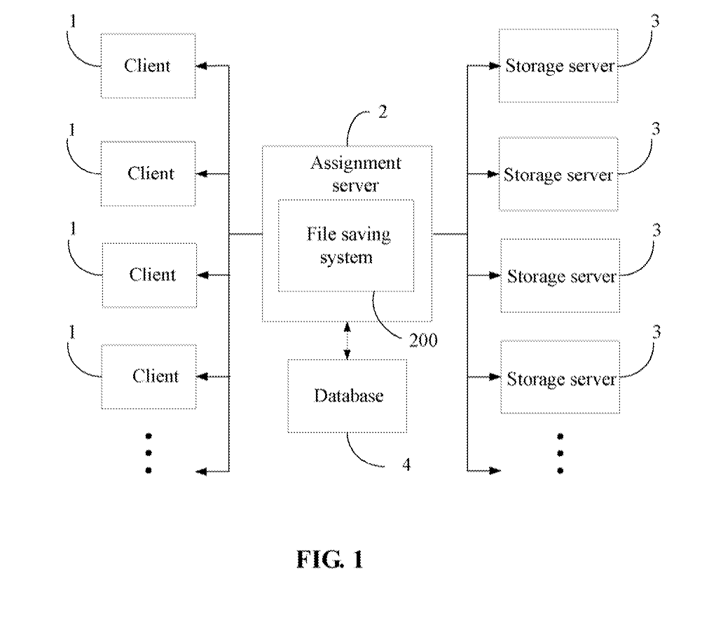

FIG. 1 is a block diagram of one embodiment of an assignment server 2. In this embodiment, the assignment server 2 includes a file saving system 200. The assignment server 2 connects to one or more client 1 via a network (e.g., the Internet or a local area network). Each client 1 may provide a user interface, which is displayed on a display device of the client 1, for a user to access the assignment server 2 and control one or more operations of the assignment server 2. The user may input an ID and a password using an input device (e.g., a keyboard) into the user interface to access the assignment server 2. The client 1 may be, but is not limited to, a mobile phone, a tablet computer, a personal computer or other data-processing apparatus. The assignment server 2 connects to one or more storage servers 3 via the network. The assignment server 2 connects to a database 4 using a data connectivity, such as open database connectivity (ODBC) or JAVA database connectivity (JDBC), for example. The one or more storage servers 3 consist of a server cluster (e.g., data center). Each storage server 3 stores files uploaded from the client 3 through the assignment server 2. In other words, the client 1 uploads the files into the assignment server 2, and the assignment server 2 sends the received files from the client 2 to the storage servers 3.

In one embodiment, the client 1 divides each file into two or more data blocks, and uploads the two or more data blocks of the file into the assignment server 2. The assignment server 2 sends the two or more data blocks of the file to the storage server 3. Additionally, before uploading the two or more data blocks of the file into the assignment server 2, the client 1 further calculates a hash value of each data block and saves the hash value of each data block into a hash list. The client 1 also includes information of the file, the information of the file includes a name of the file and an attribute of the file. Furthermore, each file corresponds to a hash list. In other words, the data blocks of the file are saved into the hash list corresponding to the file. Each data block includes a name. The name of each data block is generated in order and also saved into the hash list. In detail, the name of each data block is generated in an alphabetical order (e.g., “a,” “b,” “c,” “d,” “d,” or “f”) or in a numerical order (e.g., “1,” “2,” “3,” or “4”). For example, the file is divided into three data blocks, namely a data block “a,” a data block “b,” and a data block “c.” Each data block may include a storage capacity predetermined by a user, such as 16 KB, 32 KB, 64 KB, 128 KB, or 256 KB. For example, if the storage capacity is predetermined as 32 KB, the file is divided into a plurality of data blocks, and each data block is 32 KB.

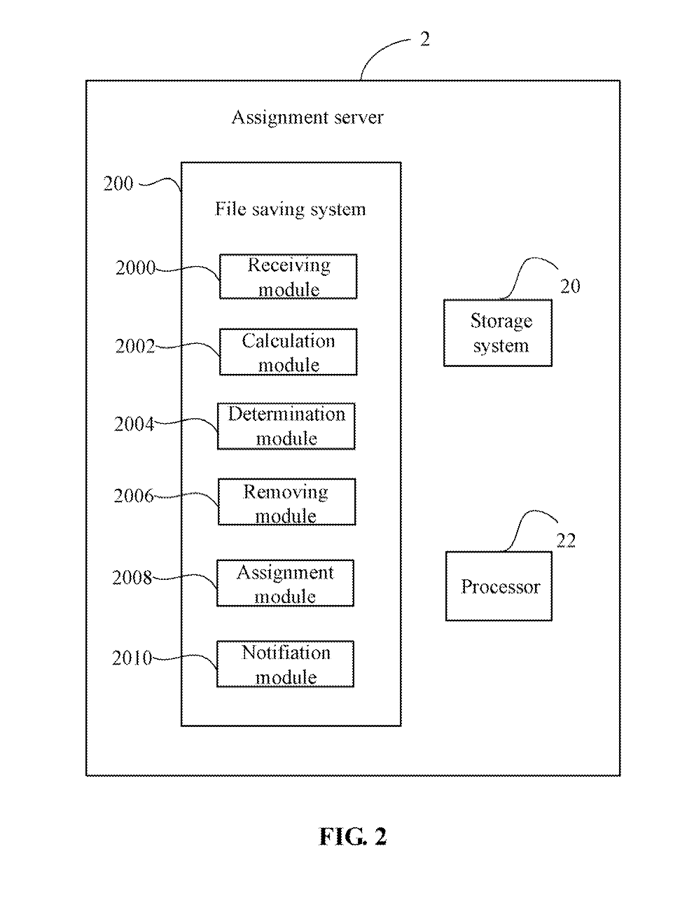

FIG. 2 is a block diagram of one embodiment of the file saving system 200 included in the assignment server 2 of FIG. 1. The file saving system 200 processes a file and uploads the processed file into a storage server 3. In one embodiment, the assignment server 2 further includes a storage system 20 and at least one processor 22. The file saving system 200 includes a receiving module 2000, a calculation module 2002, a determination module 2004, a removing module 2006, an assignment module 2008, and a notification module 2010. The modules 2000-2010 may include computerized code in the form of one or more programs that are stored in the storage system 20. The computerized code includes instructions that are executed by the at least one processor 22 to provide functions for the modules 2000-2010. The storage system 20 may be a memory, such as an EPROM memory chip, hard disk drive (HDD), or flash memory stick.

The receiving module 2000 receives a hash list corresponding to a file and information of the file uploaded from the client 1, and saves the hash list corresponding to the file and information of the file into the database 4.

The calculation module 2002 calculates a transfer process usage ratio of each storage server 3 and a remaining storage capacity of each storage server 3. In one embodiment, each storage server 3 includes a transfer process for transferring data. If the transfer process is overloading, the storage server 3 may stop transferring data. The transfer process usage ratio of each storage server 3 indicates a loading degree of the transfer process, which is a percentage. The greater the transfer process usage ratio, the more loading is imposed on the transfer process.

The determination module 2004 determines an available storage server according to the transfer process usage ratio of the storage server and the remaining storage capacity of each storage server 3. A storage server 3 is determined as the available storage server, upon the condition that the transfer process usage ratio of the storage server 3 is not more than a predetermined percentage (e.g., 80%) and the storage server 3 is available to store two or more data blocks.

The removing module 2006 searches for repetitive data blocks according to the hash value of each data block and keeps one repetitive data block by deleting other repetitive data blocks. A data block is determined as the repetitive data block upon the condition that the hash value of the data block is the same as the hash values of other data blocks. For example, if the hash value of the data block “a” is the same as the hash value of the data block “b,” the data block “a” and data block “b” are determined as repetitive blocks. The removing module 2006 may delete data block “a” from the client 1 and keep the data block “b” in the client 1.

The assignment module 2008 assigns a storage space for storing each data block in the available storage server and obtains a pointer corresponding to the data block that points to the storage space. In one embodiment, each data block corresponds to a pointer that points to the storage space. In other words, a user uses the pointer to find the storage space. The storage space may store one or more data blocks in the assignment server 2. Furthermore, even the repetitive data blocks are deleted in the client 1 for the reason of repetitiveness, each repetitive data block is also assigned to one pointer, and the pointer corresponding to the repetitive data block is the same as the pointer corresponding to the data block in the assignment server 2, wherein the repetitive data block is the same as the data block in the assignment server 2.

The notification module 2010 uploads each data block from the client 1 into the storage space corresponding to the data block according to the pointer corresponding to the data block, and sends the pointer of each data block to the client 1. The pointer of each data block is received from the assignment server 2 and displayed in a display device of the client 1.

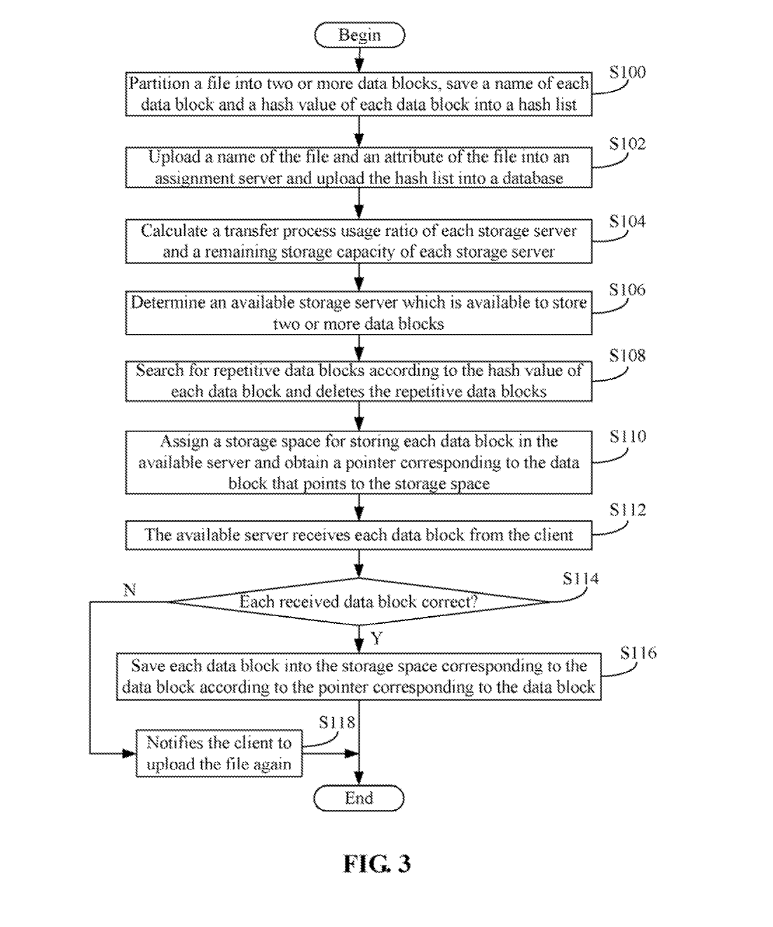

FIG. 3 is a flowchart of one embodiment of a file saving method. Depending on the embodiment, additional steps may be added, others deleted, and the ordering of the steps may be changed.

In step S100, the client 1 divides a file into two or more data blocks, saves a name of each data block and a hash value of each data block into a hash list.

In step S102, the client 1 uploads information of the file into an assignment server 2 and uploads a hash list into a database 4. The receiving module 2000 receives the information of the file and the hash list from the client 1.

In step S104, the calculation module 2002 calculates a transfer process usage ratio of each storage server and a remaining storage capacity of each storage server.

In step S106, the determination module 2004 determines an available storage server according to the transfer process usage ratio of the storage server and the remaining storage capacity of each storage server. The storage server is determined as the available storage server, upon the condition that the transfer process usage ratio of the storage server is less or equal to a predetermined percentage (e.g., 80%) and the storage server 3 is available to store two or more data blocks.

In step S108, the removing module 2006 searches for repetitive data blocks according to the hash value of each data block and keeps one repetitive data block by deleting other repetitive data blocks. For example, if the hash value of the data block “a” is the same as the hash value of the data block “b,” the data block “a” and data block “b” are determined as repetitive blocks. The removing module 2006 may delete data block “a” from the client 1 and keep the data block “b” in the client 1.

In step S110, the assignment module 2008 assigns a storage space for storing each data block in the available storage server and obtains a pointer corresponding to the data block that points to the storage space. In one embodiment, each data block corresponds to a pointer that points to the storage space. In other words, a user uses the pointer to find the storage space. The storage space may store one or more data blocks in the assignment server 2. Furthermore, even the repetitive data blocks are deleted in the client 1, however, each repetitive data block is also assigned to one pointer, and the pointer corresponding to the repetitive data block is the same as the pointer corresponding to the data block in the assignment server 2, wherein the repetitive data block is the same as the data block in the assignment server 2.

In step S112, the available storage server 3 receives each data block from the assignment server 2.

In step S114, the available storage server 3 determines if each data block is correct. In one embodiment, when the available storage server receives the data blocks from the assignment server 2, the available storage server 3 also calculates the hash value of each data block, and verifies the existence of the hash value of each data block in the hash list. If the hash value of each data block does exist in the hash list, the data block is determined to be correct, the procedure goes to step S116, and the available storage server 3 saves each data block into the storage space corresponding to the data block. If the hash value of a data block does not exist in the hash list, the data block is determined not to be correct, and the procedure goes to step S118.

In step S116, the available storage server saves each data block into the storage space corresponding to the data block according to the pointer corresponding to the data block.

In step S118, the available storage server notifies the client 1 to upload the file again. In one embodiment, the available storage server rejects the client for uploading the data blocks and notifies the client 1 that the data blocks are rejected for uploading.

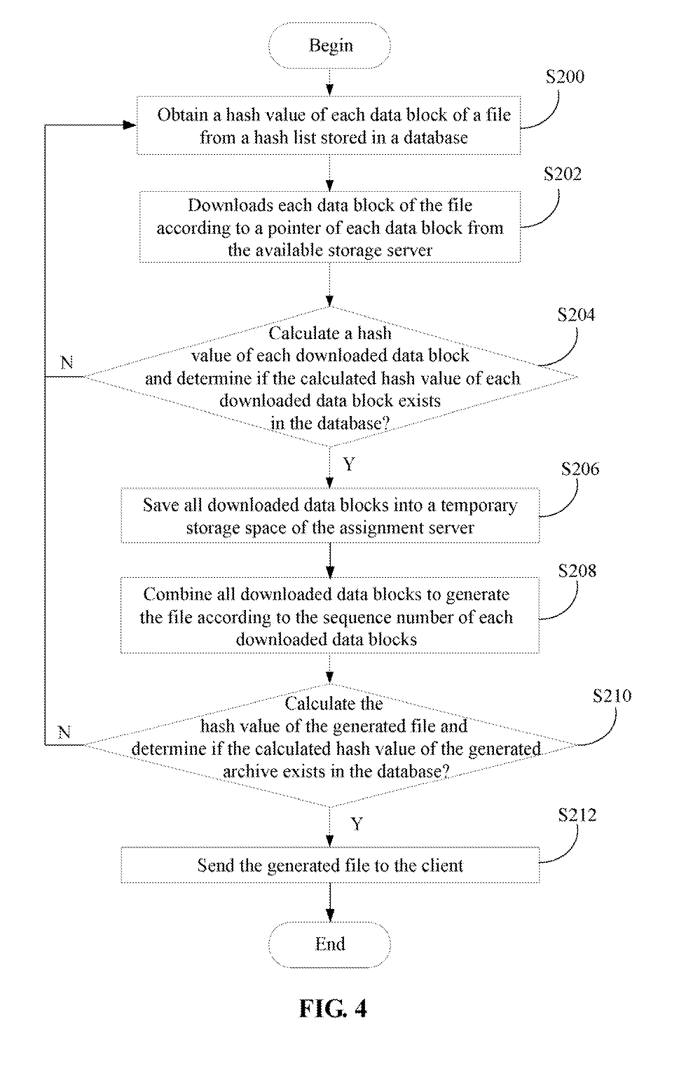

FIG. 4 is a flowchart of one embodiment of downloading a file from a server.

In step S200, the client 1 obtains a hash value of each data block of a file from a hash list stored in a database 4.

In step S202, the client 1 downloads each data block of the file according to a pointer of each data block from the available storage server.

In step S204, the download module 2012 calculates a hash value of each downloaded data block and determines if the hash value of each downloaded data block exists in the hash list stored in the database 4. In one embodiment, if the calculated hash value of each downloaded data block exists in the database 4, the procedure goes to step S206. Otherwise, if one calculated hash value of the downloaded data block does not exist in the hash list, the procedure returns to step S200.

In step S206, the client 1 saves all downloaded data blocks into a temporary storage space of the client 1.

In step S208, the client 1 combines all downloaded data blocks to generate or regenerate the file in the temporary storage space of the client 1 according to the name of each downloaded data block. The temporary storage space of the client 1 may be, but is not limited to, a random access memory (RAM). In one embodiment, due to the name of each downloaded data block being generated in order, the client 1 combines all downloaded data blocks to generate the file in the name order of each downloaded data block.

In step S210, the client 1 calculates the hash value of the generated file and determines if the calculated hash value of the generated file exists in the hash list stored in the database 4. If the calculated hash value of the generated file exists in the hash list, the client 1 displays success message (e.g., displaying “SUCCESS”) in a display device of the client 1, and the procedure goes to step S212. If the calculated hash value of the generated file does not exist in the hash list, the client 1 displays a fail message (e.g., displaying “FAIL”) in the display device of the client 1, and the procedure returns to S200.

In step S212, the client 1 sends the generated file to the display device of the client 1.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. An assignment server in electronic communication with a client and a plurality of storage server, comprising:
at least one processor; and
a storage system that stores one or more programs, when executed by the at least one processor, cause the at least one processor to perform a file saving method, the method comprising:
receiving a hash list corresponding to a file from the client, and saving the hash list corresponding to the file into the database connected to the assignment server, wherein the hash list comprises a hash value of each data block of the file, and a name of each data block;
calculating a transfer process usage ratio of each storage server and a remaining storage capacity of each storage server;
determining an available storage server according to the transfer process usage ratio of the storage server and the remaining storage capacity of each storage server;
searching for repetitive data blocks according to the hash value of each data block and keeping one repetitive data block by deleting other repetitive data blocks from the client;
assigning a storage space for storing each data block in the available storage server and obtaining a pointer corresponding to the data block that points to the storage space; and
uploading each data block from the client into the storage space corresponding to the data block according to the pointer corresponding to the data block, and sending sends the pointer of each data block to the client.

2. The assignment server of claim 1, wherein a method of dividing the file by the client comprises:
the client divides each file into two or more data blocks;
the client calculates the hash value of each data block; and
the client saves the hash value of each data block into the hash list.

3. The assignment server of claim 1, wherein the name of each data block is generated in an alphabetical order or in a numerical order.

4. The assignment server of claim 1, wherein a storage server is determined as the available storage server, upon the condition that the transfer process usage ratio of the storage server is less or equal to a predetermined percentage and the storage server is available to store two or more data blocks.

5. The assignment server of claim 1, wherein a data block is determined as a repetitive data block upon the condition that the hash value of the data block is the same as the hash values of other data blocks.

6. The assignment server of claim 1, wherein a method of saving the file into the available storage sever comprises:
the available storage sever calculates the hash value of each data block uploaded from the assignment server;
the available storage sever determines whether the hash value of each data block exists in the hash list;
the available storage sever saves each data block into the storage space corresponding to the data block according to the pointer corresponding to the data block, when the hash value of each data block exists in the hash list; and
the available storage sever notifies the client to upload the file again when one hash value of the data block does not exists in the hash list.

7. The assignment server of claim 1, wherein a method of downloading the file from the available storage server comprises:
the client obtains the hash value of each data block of the file from the hash list stored in the database;
the client downloads each data block of the file according to the pointer of each data block from the available storage server;
the client calculates a hash value of each downloaded data block, and determines if the hash value of each downloaded data block exists in the hash list stored in the database;
the client saves all downloaded data blocks into a temporary storage space of the client when the hash value of each downloaded data block exists in the hash list stored in the database;
the client combines all downloaded data blocks to generate the file in the temporary storage space of the client according to the name of each downloaded data block;
the client calculates the hash value of the generated file and determines if the calculated hash value of the generated file exists in the hash list stored in the database.

8. A file saving method implemented by an assignment server, the assignment server in electronic communication with a client and a plurality of storage servers, the method comprising:
receiving a hash list corresponding to a file from the client, and saving the hash list corresponding to the file into the database connected to the assignment server, wherein the hash list comprises a hash value of each data block of the file, and a name of each data block;
calculating a transfer process usage ratio of each storage server and a remaining storage capacity of each storage server;
determining an available storage server according to the transfer process usage ratio of the storage server and the remaining storage capacity of each storage server;
searching for repetitive data blocks according to the hash value of each data block and keeping one repetitive data block by deleting other repetitive data blocks from the client;
assigning a storage space for storing each data block in the available storage server and obtaining a pointer corresponding to the data block that points to the storage space; and
uploading each data block from the client into the storage space corresponding to the data block according to the pointer corresponding to the data block, and sending sends the pointer of each data block to the client.

9. The method of claim 8, wherein a method of dividing the file by the client comprises:
the client divides each file into two or more data blocks;
the client calculates the hash value of each data block; and
the client saves the hash value of each data block into the hash list.

10. The method of claim 8, wherein the name of each data block is generated in an alphabetical order or in a numerical order.

11. The method of claim 8, wherein a storage server is determined as the available storage server, upon the condition that the transfer process usage ratio of the storage server is less or equal to a predetermined percentage and the storage server is available to store two or more data blocks.

12. The method of claim 8, wherein a data block is determined as the repetitive data block upon the condition that the hash value of the data block is the same as the hash values of other data blocks.

13. The method of claim 8, wherein a method of saving the file into the available storage sever comprises:
the available storage sever calculates the hash value of each data block uploaded from the assignment server;
the available storage sever determines whether the hash value of each data block exists in the hash list;
the available storage sever saves each data block into the storage space corresponding to the data block according to the pointer corresponding to the data block, when the hash value of each data block exists in the hash list; and
the available storage sever notifies the client to upload the file again when one hash value of the data block does not exists in the hash list.

14. The method of claim 8, wherein a method of downloading the file from the available storage server comprises:
the client obtains the hash value of each data block of the file from the hash list stored in the database;
the client downloads each data block of the file according to the pointer of each data block from the available storage server;
the client calculates a hash value of each downloaded data block, and determines if the hash value of each downloaded data block exists in the hash list stored in the database;
the client saves all downloaded data blocks into a temporary storage space of the client when the hash value of each downloaded data block exists in the hash list stored in the database;
the client combines all downloaded data blocks to generate the file in the temporary storage space of the client according to the name of each downloaded data block;
the client calculates the hash value of the generated file and determines if the calculated hash value of the generated file exists in the hash list stored in the database.

15. A non-transitory computer-readable medium having stored thereon instructions that, when executed by an assignment server, the assignment server in electronic communication with a client and a plurality of storage servers, causing the assignment server to perform a file saving method, the method comprising:
receiving a hash list corresponding to a file from the client, and saving the hash list corresponding to the file into the database connected to the assignment server, wherein the hash list comprises a hash value of each data block of the file, and a name of each data block;
calculating a transfer process usage ratio of each storage server and a remaining storage capacity of each storage server;
determining an available storage server according to the transfer process usage ratio of the storage server and the remaining storage capacity of each storage server;
searching for repetitive data blocks according to the hash value of each data block and keeping one repetitive data block by deleting other repetitive data blocks from the client;
assigning a storage space for storing each data block in the available storage server and obtaining a pointer corresponding to the data block that points to the storage space; and
uploading each data block from the client into the storage space corresponding to the data block according to the pointer corresponding to the data block, and sending sends the pointer of each data block to the client.

16. The non-transitory computer-readable medium of claim 15, wherein a method of dividing the file by the client comprises:
dividing each file into two or more data blocks;
calculating the hash value of each data block; and
saving the hash value of each data block into the hash list.

17. The non-transitory computer-readable medium of claim 15, wherein a storage server is determined as the available storage server, upon the condition that the transfer process usage ratio of the storage server is less or equal to a predetermined percentage and the storage server is available to store two or more data blocks.

18. The non-transitory computer-readable medium of claim 15, wherein a data block is determined as the repetitive data block upon the condition that the hash value of the data block is the same as the hash values of other data blocks.

19. The non-transitory computer-readable medium of claim 15, wherein a method of saving the file into the available storage sever comprises:
the available storage sever calculates the hash value of each data block uploaded from the assignment server;
the available storage sever determines whether the hash value of each data block exists in the hash list;
the available storage sever saves each data block into the storage space corresponding to the data block according to the pointer corresponding to the data block, when the hash value of each data block exists in the hash list; and
the available storage sever notifies the client to upload the file again when one hash value of the data block does not exists in the hash list.

20. The non-transitory computer-readable medium of claim 15, wherein a method of downloading the file from the available storage server comprises:
the client obtains the hash value of each data block of the file from the hash list stored in the database;
the client downloads each data block of the file according to the pointer of each data block from the available storage server;
the client calculates a hash value of each downloaded data block, and determines if the hash value of each downloaded data block exists in the hash list stored in the database;
the client saves all downloaded data blocks into a temporary storage space of the client when the hash value of each downloaded data block exists in the hash list stored in the database;
the client combines all downloaded data blocks to generate the file in the temporary storage space of the client according to the name of each downloaded data block;
the client calculates the hash value of the generated file and determines if the calculated hash value of the generated file exists in the hash list stored in the database.
